(19) United States
(12) Patent Application Publication
(10) Pub. No.: US 2012/0271641 A1
(43) Pub. Date: Oct. 25, 2012

(54) METHOD AND APPARATUS FOR EDUTAINMENT SYSTEM CAPABLE FOR INTERACTION BY INTERLOCKING OTHER DEVICES

(75) Inventor: So-Young Kim, Seoul (KR)

(73) Assignee: SAMSUNG ELECTRONICCS CO., LTD., Suwon-si (KR)

(21) Appl. No.: 13/452,787

(22) Filed: Apr. 20, 2012

(30) Foreign Application Priority Data
Apr. 22, 2011 (KR) 10-2011-0037922

(51) Int. Cl. G10L 11/00; G06F 3/01

(52) U.S. Cl. 704/275; 345/156; 704/E11.001

(57) ABSTRACT

An apparatus and method provide interactive edutainment through connection of a smart TV and other devices (e.g., a tablet PC, a smart phone, and a projector). The method includes connecting with a control device, and when at least one main story for interactivity is stored, receiving from a user a selection of the main story to be executed through the control device. The method also includes executing the selected main story, and when a control command is received from the control device, processing the control command.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Apr. 22, 2011 and assigned Serial No. 10-2011-0037922, the entire disclosure of which is hereby incorporated by reference.

### TECHNICAL FIELD OF THE INVENTION

The present disclosure relates to an edutainment (i.e., entertainment/education) system. More particularly, the present disclosure relates to a method and apparatus for providing interactive edutainment through connection of a smart television (TV) and other devices (e.g., a tablet PC, a smart phone, and a projector).

### BACKGROUND OF THE INVENTION

Contents provided from APPLE smart TVs or GOOGLE smart TVs are focused on a Video On Demand (VOD) service such as a video service, a news service, and a music video service. Applications for the VOD service are also concentrated on provisions of unidirectional information, instead of interactive operations with a user.

A simple VOD service does not differ greatly from conventional services except that the user watches video which he or she may see through a conventional medium (e.g., a TV or a PC) or a conventional service (e.g., NETFLIX or YOUTUBE) on the TV without a restriction in time. That is, the simple VOD service lacks active interactivity between the user and contents.

Accordingly, a method and apparatus for performing, active interactivity between the user and the contents is needed.

### SUMMARY OF THE INVENTION

To address the above-discussed deficiencies of the prior art, it is a primary aspect of the present disclosure is to provide a method and apparatus for an edutainment system capable of interworking with other devices and performing interactivity.

Another aspect of the present disclosure is to provide a method and apparatus for providing edutainment for children capable of performing interactivity through connection of a smart TV and other devices (e.g., a tablet PC, a smart phone, and a projector) and allowing a user to learn information and have fun.

In accordance with an aspect of the present disclosure, an operation method of an output device in an edutainment system capable of performing interactivity is provided. The operation method includes connecting with a control device, and when at least one main story for interactivity is stored, receiving from a user a selection of the main story to be executed through the control device. The method also includes executing the selected main story, and when a control command is received from the control device, processing the control command.

In accordance with another aspect of the present disclosure, an operation method of a control device in an edutainment system capable of performing interactivity is provided. The operation method includes connecting with an output device, and when at least one main story for interactivity is stored, receiving from a user a selection of the main story to be executed. The method also includes executing the selected main story, and sending an output data to the output device.

In accordance with another aspect of the present disclosure, an apparatus of an output device in an edutainment system capable of performing interactivity is provided. The apparatus includes at least one RF modem configured to communicate with another node, a display unit configured to display data, a speaker configured to output data as a sound, and an input unit configured to receive an input of a user. The apparatus also includes a controller configured to connect with a control device through the RF modem, when at least one main story for interactivity is stored, receive from a user a select of the main story to be executed through the control device, execute the selected main story, and when a control command is received from the control device through the RF modem, process the control command.

In accordance with another aspect of the present disclosure, an apparatus of a control device in an edutainment system capable of performing interactivity is provided. The apparatus includes at least one RF modem configured to communicate with another node, a display unit configured to display data, a speaker configured to output data as a sound, and an input unit configured to receive an input of a user. The apparatus also includes a controller configured to connect with an output device through the RF modem, when at least one main story for interactivity is stored, receive from a user a selection of the main story to be executed, execute the selected main story, and send output data to the output device through the RF modem.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a system for active interactivity according to an embodiment of the present disclosure;

FIG. 2 is a block diagram illustrating an apparatus according to an embodiment of the present disclosure;

FIG. 3 is a flowchart illustrating an operation process of a smart TV according to an embodiment of the present disclosure;

FIG. 4 is a flowchart illustrating an operation process of a tablet PC or a handset according to an embodiment of the present disclosure; and

FIG. 5 is a flowchart illustrating an operation process of a projector according to an embodiment of the present disclosure.

### DETAILED DESCRIPTION OF THE INVENTION

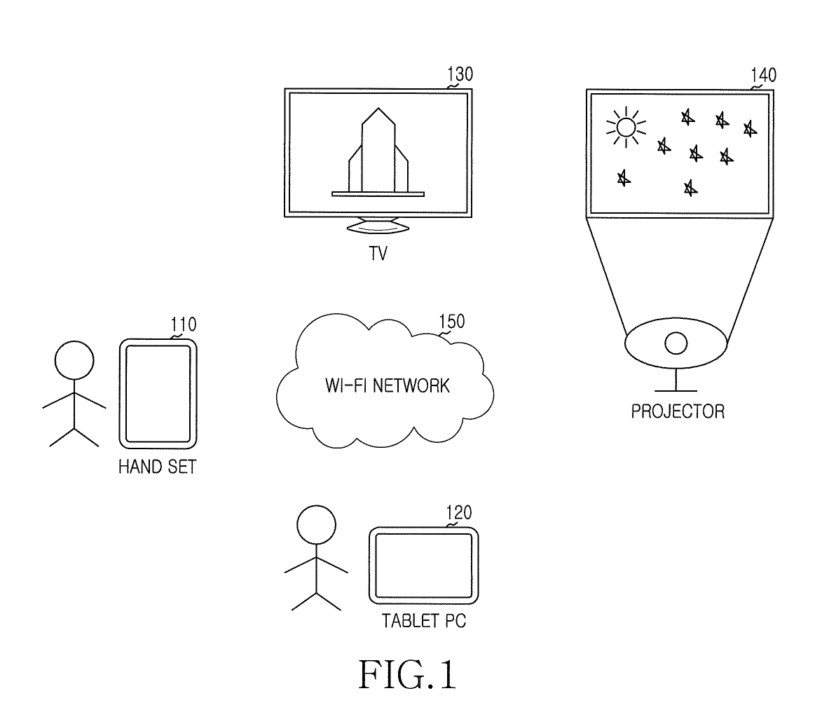

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

Hereinafter, a description will be given with respect to a method and apparatus for an edutainment system capable of interworking with other devices and performing interactivity.

Surrogate travel applications represent one of the most popular application categories among categories for child education. In a surrogate travel application, a user may freely travel where it would be impossible for him or her to go in the real world, such as travel to the Jurassic period in which dinosaurs lived, space travel out of ancient Egypt, travel to “twenty thousand leagues under the sea”, exploration of the human body, and the like.

In accordance with the present disclosure, the user may look around a virtual world. That is, the user may also look around places where he or she may go directly in the real world in detail through a smart TV, such as famous museums, zoos, cities, and the like, as well as fictional places like “Hogwarts School of Witchcraft and Wizardry” in the “Harry Potter” stories and “Avonlea”, the home of “Ann of Green Gables”.

In accordance with the present disclosure, it is sufficient to have one TV to start surrogate travel to be different from travel in the real world in which the user must pack a suitcase full of belongings, a passport, a map, a camera, and so forth.

The user may see every part of a surrogate travel location very well. If the user has a control pad with a Liquid Crystal Display (LCD), he or she may interact with big and small events from the surrogate travel location according to its circumstances. If the user has a projector which changes a background of the surrogate travel place, so much the better.

The surrogate travel application has excellent educational effects. The user gains knowledge in advance by learning the unknown in advance when starting the unknown. The user experiences everything he or she sees and hears at the surrogate travel place and events in the surrogate travel place.

Particularly, in accordance with features of the surrogate travel application, the surrogate travel application does not show contents to the user as the contents are just broadcasted on the smart TV, but allows the user to exchange interactivity with the contents and grow up himself or herself through a remote controller of the smart TV. The surrogate travel application does not list simple things which the user may see in the surrogate travel place but adds a mission or a story in connection with an event in the surrogate travel place to encourage the user to exercise his or her imagination.

The surrogate travel application also reinforces family bonding. Of course, the user may enjoy the surrogate travel application alone. Also, the user may also enjoy the surrogate travel application together with teachers or friends at school instead of family in home.

Assuming that target users are family members and a place for use of the surrogate travel application is their house, a description will be given as follows. If there is a child above the age of five among the target users, the surrogate travel application may provide contents for allowing the child to challenge new things, have a great desire to perform the surrogate travel application by himself or herself, have a great desire to see and feel the surrogate travel application firsthand, and enjoy the surrogate travel application together with friends. If a plurality of these contents exists, a variety of needs of children may be satisfied. The child is suitable for a main role of the contents in a scenario.

If there are parents among the target users, the parents want to encourage their children to use their imagination, want to spend as much time as possible with their children, and want to be good parents. A mother is suitable for an assistant role and a father is suitable for a progressing assistant role between the parents in a scenario.

If there is a brother or a friend among the target users, and if there are a plurality of main characters, the brother or the friend is suitable for another main role in a scenario.

Assuming that target users are members in a class and a place for use of the surrogate travel application is their classroom, a description will be given as follows. If there is a child above the age of five among the target users, the surrogate travel application may provide contents for allowing the child to challenge new things, have a great desire to perform the surrogate travel application by himself or herself, have a great desire to see and feel the surrogate travel application firsthand, and enjoy the surrogate travel application together with friends. If a plurality of these contents exists, a variety of needs of children may be satisfied. The child is suitable for a main role of the contents in a scenario.

If there is a teacher among the target users, the teacher wants to provide a variety of curriculums capable of attracting the children's interest. A role of the teacher is similar to that of the parents in a scenario.

If there is a friend among the target users, and if there are a plurality of main characters, the friend is suitable for another main role in a scenario.

FIG. 1 illustrates a structure of a system for active interactivity according to an embodiment of the present disclosure.

Referring to FIG. 1, the system may include a handset 110, a tablet Personal Computer (PC) 120, a smart TV 130, and a projector 140. The handset 110, the tablet PC 120, the smart TV 130, and the projector 140 may use a Wi-Fi network 150 to perform local area communication.

A main story may be developed on the smart TV 130. The development of the main story may be changed according to interactivity through other devices. The other devices may be the handset 110 and the tablet PC 120. A user may select a menu, input a command, or develop the main story using the handset 110 or the tablet PC 120. The tablet PC 120 may control a mission execution function or a menu selection function according to the main story developed on the smart TV 130. The user holds the tablet PC 120, touches a screen of the tablet PC 120, and may receive feedback as a vibration or a sound.

The handset 110 helps the tablet PC 120 to perform its function. That is, if the tablet PC 120 performs a main function, the handset 110 may perform a sub-function.

The projector 140 displays a suitable image or moving picture as a background according to the development of the main story. The handset 110 or the tablet PC 120 may output data to be displayed to the projector 140.

Each of the tablet PC 120, the handset 110, and the smart TV 130 includes a camera. The camera photographs a corresponding object or person and may apply the photographed object or person image to the main story. In some embodiments, only a partial image may also be used from the person or object image photographed by the camera.

Also, each of the tablet PC 120, the handset 110, and the smart TV 130 recognizes a face or motion of a person and may reflect the recognized information to the main story. That is, each of the tablet PC 120, the handset 110, and the smart TV 130 recognizes the face or motion of the person and may reflect the recognized information to an output picture of the main story when an expression of the face or the motion of the person is changed.

In addition, each of the tablet PC 120, the handset 110, and the smart TV 130 recognize a voice of the user. For example, if the user says “it is a red brick house of two floors”, each of tablet PC 120, the handset 110, and the smart TV 130 displays template images for diverse red brick houses of two floors and may allow the user to select the template image.

For example, when the main story is about space travel, it is possible to develop the main story as follows.

First, a process of selecting a destination of the space travel is performed.

The smart TV 130 displays an image for asking the destination, such as, “There are many planets in the universe. We are living on Earth. Where do you want to go to today?” Alternatively, these contents may be output as audible speech sounds.

The user who uses the tablet PC 120 touches a touch screen with his or her finger and touches the destination. For example, the user zooms in on a picture, rotates the picture, moves the solar system, and may select the moon, which is a satellite of the Earth.

Alternatively, the user speaks into a microphone of the tablet PC 120 to a destination and may select the destination through the speech. That is, if the user says “the moon”, the tablet PC 120 may recognize “the moon” as the destination through voice recognition.

A time to arrive at the destination is determined. Herein, assuming that the destination is set to “the moon”, a description will be given later.

The smart TV 130 displays an image, such as a picture that conveys the following contents: “The moon is 384,400 kilometers away from the Earth. If you walk (at a speed of 8 km/h), it takes five years to arrive at the moon. If you travel by a car (which is moving at a speed of 100 km/h), you arrive at the moon in 160 days. If you board a plane (which flies in the sky at a speed of 500 km/h), it takes 32 days to arrive at the moon. If you board a jet (which flies at a speed of 800 km/h), it takes 20 days to arrive at the moon. If you travel in a spacecraft (which flies at the speed of 100,000 km/h), how long will it take to arrive at the moon? Hint: distance/speed=time”. Alternatively, these contents may be output as audible speech sounds.

In this situation, the user who uses the tablet PC 120 may find the answer using a calculator displayed on the picture of the tablet PC 120.

Thereafter, a process of decorating a spacecraft is performed.

The smart TV 130 displays an image, such as a picture that conveys the following: “We will go to the moon by the spacecraft which is faster than cars, is faster than planes, and is faster than jets. Do you want to decorate the spacecraft by which we will go to the moon?” Alternatively, these contents may be output as audible speech sounds. In this situation, the user who uses the tablet PC 120 may color the spacecraft displayed on the picture of the tablet PC 120.

Thereafter, a process of selecting a person who goes to the moon together with the main character for the space travel is performed.

The smart TV 130 displays an image, such as a picture that conveys the following: “Who will go on the space travel starting to the moon today? Please, stand in front of a camera and take a photograph of yourself.” (when a face of the user is not recognized and the user is simply photographed by the camera). Alternatively, the picture may convey, “Who will go on the space travel starting to the moon today? Please, take your cockpit of the spacecraft”, which guides the user to stand in front of the camera when performing face recognition in real time using the camera. Alternatively, these contents may be output as audible speech sounds.

The user stands in front of the camera and photographs his or her face. If a picture of the user who wore a spacesuit is output on the smart TV 130 or the user sits on a designated cockpit in front of the camera, the smart TV 130 recognizes the user and outputs the user who wore the spacesuit. The smart TV 130 recognizes the user continuously.

If a picture conveying “Please give your name” is displayed on the smart TV 130 or if the message is output as audible speech sounds, the user enters his or her name directly using the tablet PC 120 or speaks in a voice and inputs the his or her name through speech.

Alternatively, the smart TV 130 displays an image, such as a picture that conveys the following: “Who is a colleague who will go to the moon together with a pilot of the spacecraft today? Please, stand in front of a camera and take a photograph of you.” In this situation, the aforementioned process (the user selection and photographing process) may be repeated.

Thereafter, a process of starting the space travel is performed.

The smart TV 130 displays an image, such as a picture that conveys the following: “The Apollo which starts to the moon is about to depart. Please, prepare all passengers in the spacecraft to start to the moon at their seats.” The user may verify an auxiliary user through the tablet PC 120. The auxiliary user sends voices and pictures using the handset 110. Or, these contents may be output as voices.

The user clicks a screen of the tablet PC 120 and informs that “all systems go.”

Thereafter, if a countdown is started, the smart TV 130 outputs the counted number and sound. Also, the projector 140 outputs a changed atmosphere shape around the spacecraft. The smart TV 130 displays a picture on which the spacecraft goes to the universe through the Earth's atmosphere.

The tablet PC 120 displays a picture of the universe through a window of the spacecraft.

It is possible to provide a variety of contents in addition to this space travel. For example, it is possible to provide travel to another time such as the Jurassic period or a period of ancient Egypt; travel to very cold places such as the universe, the deep sea, or the North Pole; and places invisible to the naked eye such as a human body, Empire of The Ants, and electricity; travel to a country in a novel or movie and an imaginary country such as a virtual world directly made by a user. It will be understood that the present disclosure is not limited to the application of the travel.

The following business partners may be considered to link contents of the smart TV in Business to Business (B2B). The business partners, for example, are educational institutions such as a kindergarten, an elementary school, and a private educational institute; work-study institutions such as a museum, an art gallery, a zoo, and a botanical garden; and conventional contents possession companies such as a publishing company and a game company.

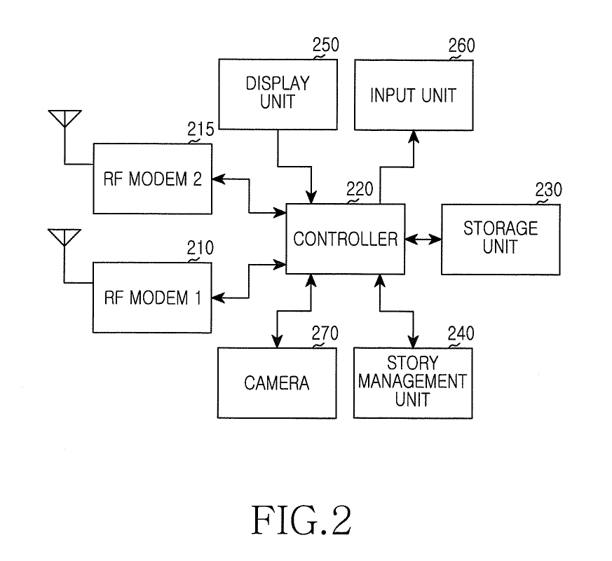

FIG. 2 is a block diagram illustrating an apparatus according to an embodiment of the present disclosure.

Referring to FIG. 2, the apparatus includes a Radio Frequency (RF) modem 1 210, an RF modem 2 215, a controller 220, a storage unit 230, a story management unit 240, a display unit 250, an input unit 260, and a camera 270. The controller 220 may include the story management unit 240.

The RF modem 1 210 and the RF modem 2 220 are modules for communicating with other devices. Each of the RF modem 1 210 and the RF modem 2 220 includes a RF processing unit, a baseband processing unit, and the like. The RF processing unit converts a signal received through an antenna into a baseband signal and provides the baseband signal to the baseband processing unit. The RF processing unit converts a baseband signal from the baseband processing unit into an RF signal to transmit the RF signal on a wireless path and transmits the RF signal through the antenna.

The present disclosure is not limited to radio access technology of the RF modem 1 210 and the RF modem 2 220. The apparatus according to the present disclosure may include only the RF modem 1 210. Alternatively, the apparatus according to the present disclosure may include the RF modem 1 210 and the RF modem 2 220.

The controller 220 controls an overall operation of the apparatus. Particularly, the controller 220 controls the story management unit 240 according to the present disclosure.

The storage unit 230 stores a program for controlling the overall operation of the apparatus and temporary data generated while the program is executed. Particularly, the storage unit 230 stores a main story for interactivity.

The display unit 250 displays output data of the controller 220 and output data of the story management unit 240. Although it is not shown in FIG. 2, if the output data is sound data, it is understood that a speaker outputs the output data as a sound.

The input unit 260 provides data input by a user to the controller 220. The input data may be a sound data or a touch data according to a kind of the input data.

The camera 270 provides photographed data to the controller 220.

The story management unit 240 processes a function for active interactivity according to the present disclosure.

Functions of the story management unit 240 will be described later in detail.

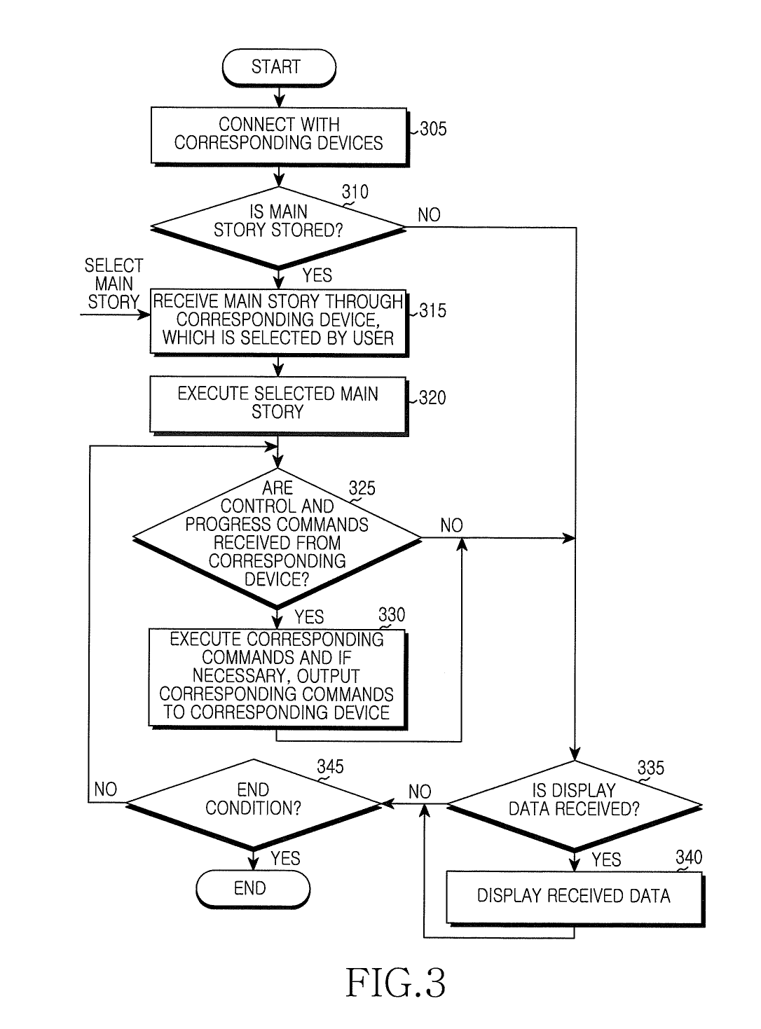

FIG. 3 is a flowchart illustrating an operation process of a smart TV according to an embodiment of the present disclosure.

Referring to FIG. 3, the aforementioned story management unit is connected with other corresponding devices (e.g., a tablet PC, a handset, and a projector) (block 305). Radio access technology for the connection may be Wi-Fi technology. However, the present disclosure is not limited to radio access technology for the connection. Each of the corresponding devices may be a control device.

If at least one main story for interactivity according to the present disclosure is stored (block 310), the story management unit outputs types of main stories stored through the corresponding devices (e.g., the tablet PC, the handset, and the like) from a user. The story management unit receives a main story to be used by the user, which is selected by the user (block 315). The story management unit executes the selected main story (block 320). The main story, for example, may be space travel. It will be understood that the prevent disclosure is not limited to a particular type of main story.

If a control command, a progress command, and the like are received from the corresponding devices (e.g., the tablet PC, the handset, and the like) (block 325), the story management unit executes the received commands. If necessary, the story management unit outputs the control command and the progress command or an output data to the corresponding devices (block 330). The user may verify the result as a sound or a picture through the corresponding devices.

If display data is received from the corresponding devices (block 335), the story management unit displays the received display data on a picture (block 340).

The processes described in blocks 325 to 340 are repeated until the main story is ended (block 345).

The story management unit may recognize a specific object from an image photographed by a camera and may extract the specific object from the image. The story management unit may recognize voice data from received data and may operate according to the recognized voice data.

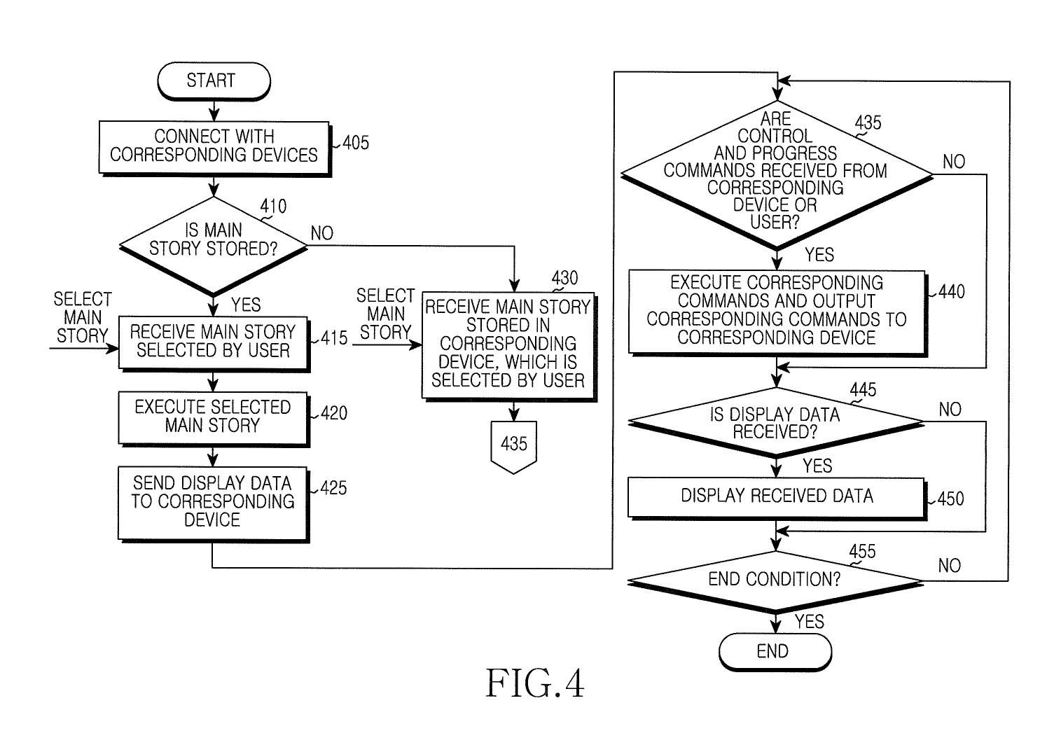

FIG. 4 is a flowchart illustrating an operation process of a tablet PC or a handset according to an embodiment of the present disclosure.

Referring to FIG. 4, the aforementioned story management unit is connected with other corresponding devices (e.g., a smart TV and a projector) (block 405). Radio access technology for the connection may be Wi-Fi technology. The present disclosure is not limited to radio access technology for the connection. Each of the corresponding devices may be an output device.

If at least one main story for interactivity according to the present disclosure is stored (block 410), the story management unit outputs types of main stories stored from a user. The story management unit receives a main story to be used by the user, which is selected by the user (block 415). The story management unit executes the selected main story (block 420). The main story, for example, may be space travel. It will be understood that the prevent disclosure is not limited to a particular type of main story. In this process, the story management unit may send a display data to the corresponding device (e.g., the smart TV, the projector, or a handset) (block 425).

If a control command, a progress command, and the like are received from the corresponding devices (e.g., the smart TV, the handset, and the like) or the user (block 435), the story management unit executes the received commands. If necessary, the story management unit outputs progress data or output data to the corresponding devices (block 440). The user may verify the result as a sound or a picture through the corresponding devices.

If display data is received from the corresponding devices (block 445), the story management unit displays the received display data on a picture (block 450).

These processes described in blocks 435 to 450 are repeated until the main story is ended (block 455).

If the main story is stored in the corresponding device (e.g., the smart TV or the handset), the story management unit outputs the main story stored in the corresponding device. The story management unit receives the main story to be executed, which is selected by the user (block 430). The story management unit performs the processing from block 435.

The story management unit may recognize a specific object from an image photographed by a camera and may extract the specific object from the image. The story management unit may recognize voice data from received data and may operate according to the recognized voice data.

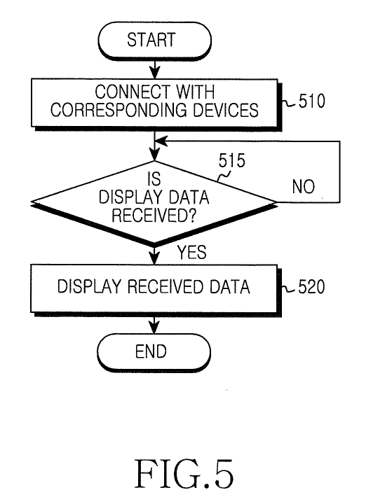

FIG. 5 is a flowchart illustrating an operation process of a projector according to an embodiment of the present disclosure.

Referring to FIG. 5, the aforementioned story management unit is connected with corresponding devices (e.g., a smart TV, a tablet PC, and a handset) (block 510).

If display data is received from the corresponding devices (block 515), the story management unit displays the received data (block 520). If necessary, if the received data is sound data, the story management unit may output the sound data through a speaker.

The present disclosure may provide active interactivity through connection of the smart TV and other devices (e.g., the tablet PC, the smart TV, and the projector).

It will be appreciated that embodiments of the present disclosure according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present disclosure.

Accordingly, embodiments provide a program comprising code for implementing an apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An operation method of an output device in an edutainment system capable of performing interactivity, the operation method comprising:
connecting with a control device;
when at least one main story for interactivity is stored, receiving a selection of the main story to be executed through the control device;
executing the selected main story; and
when a control command is received from the control device, processing the control command.

2. The operation method of claim 1, further comprising, when display data is received from the control device, displaying the received display data.

3. The operation method of claim 1, wherein the processing of the control command comprises displaying generated output data or outputting the generated data as a sound when processing the control command.

4. The operation method of claim 1, wherein the control device includes at least one of a tablet PC and a handset.

5. The operation method of claim 1, further comprising:
recognizing a specific object from an image photographed by a camera; and
extracting the specific object from the image.

6. The operation method of claim 1, further comprising recognizing voice data from received data and operating according to the recognized voice data.

7. An operation method of a control device in an edutainment system capable of interactivity, the operation method comprising:
connecting with an output device;
when at least one main story for interactivity is stored, receiving a selection of the main story to be executed;
executing the selected main story; and
sending an output data to the output device.

8. The operation method of claim 7, further comprising, when a control command is received from the output device or the user, processing the control command.

9. The operation method of claim 8, wherein the processing of the control command comprises displaying generated output data or outputting the generated output data as a sound when processing the control command.

10. The operation method of claim 7, wherein the output device includes at least one of a smart TV and a projector.

11. The operation method of claim 7, further comprising:
recognizing a specific object from an image photographed by a camera; and
extracting the specific object from the image.

12. The operation method of claim 7, further comprising recognizing voice data from a received data and operating according to the recognized voice data.

13. An apparatus of an output device in an edutainment system capable of performing interactivity, the apparatus comprising:
at least one RF modem configured to communicate with another node;
a display unit configured to display data;
a speaker configured to output data as a sound;
an input unit configured to receive an input; and
a controller configured to connect with a control device through the RF modem, when at least one main story for interactivity is stored, receive a selection of the main story to be executed through the control device, execute the selected main story, and when a control command is received from the control device through the RF modem, process the control command.

14. The apparatus of claim 13, wherein when a display data is received from the control device, the display unit displays the received display data.

15. The apparatus of claim 13, wherein the controller displays generated output data on the display unit or outputs the generated data as a sound through the speaker when processing the control command.

16. The apparatus of claim 13, wherein the control device includes at least one of a tablet PC and a handset.

17. The apparatus of claim 13, wherein the controller recognizes a specific object from an image photographed by a camera and extracts the specific object from the image.

18. The apparatus of claim 13, wherein the controller recognizes voice data from data received through the input unit and operates according to the recognized voice data.

19. An apparatus of a control device in an edutainment system capable of interactivity, the apparatus comprising:
at least one RF modem configured to communicate with another node;
a display unit configured to display data;
a speaker configured to output data as a sound;
an input unit configured to receive an input; and
a controller configured to connect with an output device through the RF modem, when at least one main story for interactivity is stored, receive a selection of the main story to be executed, execute the selected main story, and send output data to the output device through the RF modem.

20. The apparatus of claim 19, wherein when a control command is received through the RF modem from the output device or through the input unit from the user, the controller processes the control command.

21. The apparatus of claim 20, wherein the controller displays generated output data on the display unit or outputs the generated output data as a sound through the speaker when processing the control command.

22. The apparatus of claim 19, wherein the output device includes at least one of a smart TV and a projector.

23. The apparatus of claim 19, wherein the controller recognizes a specific object from an image photographed by a camera and extracts the specific object from the image.

24. The apparatus of claim 19, wherein the controller recognizes voice data from data received through the input unit and operates according to the recognized voice data.
